(19) United States
(12) Patent Application Publication
(10) Pub. No.: US 2007/0036336 A1
(43) Pub. Date: Feb. 15, 2007

(54) Subscriber line circuit for communication systems and communication system

(75) Inventor: Wilhelm Wimmreuter, Munich (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft, Munechen Germany (DE)

(21) Appl. No.: 10/571,053

(22) PCT Filed: Aug. 31, 2004
(86) PCT No.: PCT/EP04/51972

§ 371 Date: Mar. 7, 2006

(30) Foreign Application Priority Data
Sep. 8, 2003 (DE) 103-41-363.4

(51) Int. Cl. H04M 1/00

(52) U.S. Cl. 379/399.01

(57) ABSTRACT

In one aspect a communication system is provided wherein subscriber line circuits are connected to the communication network via a packet-based network. The subscriber line circuit comprises protocol interfaces for communicating with different network elements of the communication system and for the bi-directional conversion of information, which is transmitted from and to subscriber terminals on the subscriber side, into the information that is transmitted from and to the communication system on the network side.

### CROSS REFERENCE TO RELATED APPLICATIONS

This application is the US National Stage of International Application No. PCT/EP2004/051972, filed Aug. 31, 2004 and claims the benefit thereof. The International Application claims the benefits of German application No. 10341363.4 DE filed Sept. 8, 2003, both of the applications are incorporated by reference herein in their entirety.

### Field of the Invention

The present invention relates to a subscriber line circuit for a communication system.

### BACKGROUND OF INVENTION

Subscriber line circuits for communication systems, in particular for telecommunication systems, known also as subscriber line modules SLM, are today typically embodied as TDM (TDM=Time Division Multiplex) modules or xDSL (DSL=Digital Subscriber Line) modules, with xDSL being a customary designation for any DSL system, for example the SDSL symmetrical DSL system, the ADSL asymmetrical DSL system, the HDSL DSL system having a high data rate, or the VDSL DSL system having a very high data rate. Combined modules are also frequently encountered that support both TDM and xDSL, or a subscriber line circuit is assigned one TDM and one xDSL module.

TDM modules in subscriber line circuits therein have coding systems or, as the case may be, codecs and complex embedding in concentrators with switching network arrangements. xDSL modules in subscriber line circuits are typically connected to concentrators embodied as ATM systems or other packet systems. A concentrator is herein understood as being a device that concentrates the connecting lines of many terminating devices onto a few lines connected to a central unit or a network node.

### SUMMARY OF INVENTION

Arrangements of said type have the following disadvantages:
I. Different communication servers, for example servers for conventional telephony in the PSTN (PSTN=Public Switched Telephone Network), servers for Voice-over-Internet Protocol (VOIP) services, and servers for data services, can only be accessed via gateways. Said gateways require complex software.
II. The actual service or, as the case may be, service feature is as a rule accessible only via multi-stage mediation or, as the case may be, translation. Each (logical) termination in a partial network and each mediation will in turn increase the operating costs, and some subsystems or, as the case may be, partial networks are already suffering from a lack of available addresses.
III. Duplicated concentration stages are necessary for the combining of broadband accesses, for example xDSL, and conventional narrow-band accesses, via TDM.
IV. Both the switching networks for the narrow-band portion or, as the case may be, TDM portion and the ATM switches for the xDSL portion are expensive. The ATM switches are, moreover, complex in configuration terms.
V. Resources, for example tones, tone receivers, and announcements, must be provided centrally.

Known measures for at least partially circumventing these problems provide for separating filters or splitters. The subscriber line is routed to the broadband system and narrow-band systems via separating filters or splitters and different subscriber line circuit modules.

However, these measures provide no termination in the subscriber line circuit for analog modem accesses. Rather it is the case that a TDM connection to a narrow-band remote access server is required for a modem access. Valuable resources are tied up right across the TDM network by these connections.

Subscriber line circuits having separating filters and splitters furthermore cannot forward a data stream generated at the subscriber side using the Internet Protocol transparently to Internet Protocol-based networks.

Rather it is the case that a mediation is required that can be embodied as a modem bank and is sited downstream of the subscriber line circuit. Said arrangements are expensive and give rise to a high level of configuration and maintenance overhead as well as to expensive connections in the PSTN from the subscriber line circuit to the modem bank, frequently across several switching centers.

An object of the present invention is therefore to disclose a subscriber line circuit for communication systems and a communication system by means of both of which the cited problems are avoided.

Said object is achieved by means of the features of the independent claims. Preferred embodiments are indicated in the dependent claims.

A communication system is inventively provided which is characterized in that subscriber line circuits are connected to the communication system by means of a packet-based network which can be, for example, an access network or the internet.

The invention further relates to suitable subscriber line circuits. Apart from means for communicating with the packet-based network, these have the following:
VI. Protocol means for communicating with different network elements of the communication system, and
VII. means for bi-directionally converting the information transmitted by the subscriber-side communication means to and from subscriber terminals into the information transmitted by the network-side communication means to and from the communication system.

An inventive subscriber line circuit can advantageously have the following:
VIII. Means for connecting conventional TDM subscriber terminals,
IX. means for connecting conventional xDSL subscriber terminals,
X. means for terminating modem connections,
XI. means for voice coding and voice decoding (what are termed codecs, for example A-law or μ-law codecs),
XII. transmitting means for tones and/or announcements, and/or
XIII. receiving means for tones.

The network-side communication means are connected to the packet-based network preferably by means of at least one Ethernet interface.

The inventive communication system can advantageously have the following:
XIV. At least one network element having means for coupling the network to switching centers of the conventional circuit-switched telephone network, and/or
XV. network elements for making services and service features available: gatekeepers and/or proxy servers for Voice-over-Internet Protocol services and/or elements for controlling access and/or for user authentication and/or routers for directly accessing packet-based communication networks.

A major advantage of the invention is that the interface toward the subscriber will not have to change if favorable packet-based technology is employed between the subscriber line circuits and actual service(s), which is to say in the packet-based network (for example in the access network or internet). All known and implemented services and service features will at the same time continue to be available to the subscriber without any restrictions.

The expensive access networks of the prior art, for example the switching network arrangements and ATM access networks, can advantageously be dispensed with thanks to the invention. Also dispensable is the need to maintain dual access networks in cases where, for example, TDM services and xDSL services are offered in parallel. According to the invention only one access network is required for providing multiple services. The concentrators can likewise be dispensed with because bandwidth is usually more economical than a concentrator solution in the packet-based access networks, in particular when LAN technologies are used.

Further advantages are:
XVI. The invention makes a pure cell-based access system possible for TDM (narrow-band) and broadband subscriber accesses.
XVII. Conventional local switching centers can, after being expanded to include packet interfaces, also make their range of features available for packet-based subscriber line circuits.
XVIII. Different servers can communicate with a subscriber line circuit simultaneously, which is to say the subscriber line circuit supports linking to a plurality of services. That allows simultaneous use by a subscriber of different communication servers, for example conventional telephony, internet access, and Voice-over-IP. It furthermore allows new services to be implemented in the network more simply without having to modify the subscriber line circuit.
XIX. New transport technologies between the subscriber and communication system are converted to a simple protocol in the subscriber line circuit itself.
XX. Local switching centers can be simplified or replaced.
XXI. Computing power for mediating between TDM, analog, IP, and ATM is decentralized.
XXII. Access networks are far easier to administer and dimension.
XXIII. Tones can be produced directly in the subscriber line circuit; announcements can be transmitted in the form of, for example, files to the subscriber line circuit and played back there.
XXIV. Tone and voice recognition for recording address and control information can take place in the subscriber line circuit.
XXV. Packet-based telephony protocols such as H.323 and SIP can be converted to TDM in the subscriber line circuit or, alternatively, routed through up to the subscriber terminals.
XXVI. Saving in packet network addresses because the media discontinuity between local networks on the subscriber side, the access network and the transport networks is avoided or at least reduced thanks to the invention.
XXVII. Subscriber cards can be loaded with individual software mutually independently owing to their being linked after the power supply has been switched on.
XXVIII. Components like the controller for subscriber line circuits are dispensable because the subscriber line circuits operate autonomously.
XXIX. The “second” conversion of the useful channel (bearer channel) usually required owing to the use of media gateways is no longer necessary since conversion to the packet format already takes place in the subscriber line circuit.
XXX. Previous links are implemented as physical wire connections that have to be rewired or, as the case may be, rejumpered when the link changes. Such changes are necessary, for example, to ensure optimum performance for all connected subscribers in certain connection configurations. This expensive and complex rejumpering is rendered unnecessary by the inventive subscriber line circuits. The access networks are far easier to dimension.
XXXI. Owing to the high efficiency of even the simplest DSPs, the additional functions of the inventive subscriber line circuits could basically be performed by the hardware of existing subscriber line circuits. The costs of manufacturing the inventive subscriber line circuits are thus equal to or less than those of manufacturing the subscriber line circuits according to the prior art. For example, the components required for implementing an Ethernet interface cost far less than those needed for implementing a classical TDM interface.

### BRIEF DESCRIPTION OF THE DRAWINGS

An exemplary embodiment of the invention is explained in more detail below with reference to two figures.

FIG. 1 shows an exemplary embodiment of the invention having a communication system in which an inventive subscriber line circuit is connected to an access network.

FIG. 2 shows a further exemplary embodiment of the invention in which the inventive subscriber line circuit is directly connected to the packet network.

### DETAILED DESCRIPTION OF INVENTION

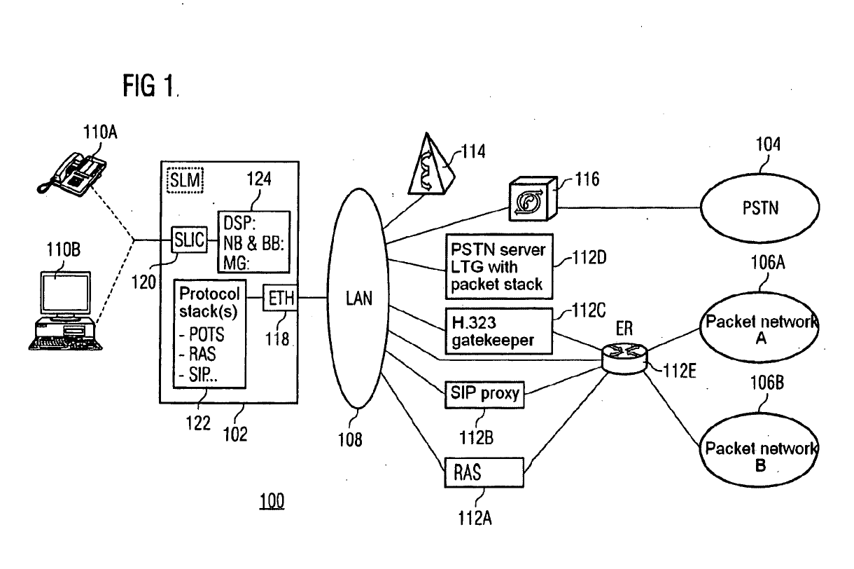

FIG. 1 is a schematic of a communication system 100 according to a characteristic of the present invention. The communication system 100 has an inventive subscriber line circuit 102. The communication system 100 can be roughly subdivided into transport networks 104, 106A-B and one or more access networks or intermediate networks 108.

The transport networks 104, 106A-B serve to transport information, with both signaling information and useful information being transported. FIG. 1 is an exemplary presentation of a conventional telephone network PSTN (PSTN=Public Switched Telephone Network) 104 and two packet networks 106A-B. Not shown are terminal points connected to the respective transport networks and switching elements of the transport networks; this is because a multiplicity of embodiments of transport networks, switching elements, and terminal points are well known in the art.

The access network 108 serves to provide subscriber terminals 110A-B with access to the transport networks 104, 106A-B. According to the present invention the access network 108, formed in the prior art by complex switching network arrangements and/or expensive ATM networks, is a simple and economical packet network, for example a local, Ethernet-based LAN network.

Information can be transmitted over said access network 108 on the basis of the Internet Protocol IP, for example to and from one of the following network elements 112A-112E: Remote Access Service (RAS) element 112A, Session Initiation Protocol (SIP) proxy 112B, ITU-T H.323 gatekeeper 112C, PSTN call server 112D, and edge router (ER) 112E. The edge router 112E is located at the interworking point to the packet-based transport networks. Other network elements (not shown) can be necessary in the access network 108 depending on the communication protocol used. The access network 108 can be connected to the PSTN 104 via a converter element 116.

Information serving to control the subscriber line circuit 102 is furthermore transmitted over the access network 108. A softswitch 114, for example, can be provided for supplying this control. In conjunction with a softswitch, what is termed the Ancillary Control Protocol ACP can be used for transmitting control and status information to and from the subscriber line circuit 102.

The inventive subscriber line circuit 102 preferably has the following: network-side communication means 118, for example at least one Ethernet interface ETH; subscriber-side communication means 120, for example at least one circuit known as a Subscriber Line Interface Circuit SLIC; protocol means 122 for communicating with the different network elements 112A-E, 114, 116 in the form of, for example, what are termed protocol stacks for all required protocols such as RAS, SIP, conventional telephony POTS (“Plain Old Telephone Service”), likewise for the Internet Protocol IP as the transport protocol.

The subscriber line circuit 102 furthermore has processor means 124 providing bi-directional conversion into packet form of the information received and sent as subscriber signals over the subscriber-side communication means 120. The processor means 124 can have, for example, a Digital Signal Processor DSP.

The processor means 124 can furthermore have functions for voice coding and voice decoding, for example codecs such as A-law or μ-law, as well as tone receivers, tone generators or, as the case may be, tone transmitting means and announcement generators or, as the case may be, announcement means. The announcements can, for example, be conveyed in coded form to the announcement generators and converted there into spoken form.

Modem functions can furthermore be advantageously provided in the inventive subscriber line circuit 102, for example likewise implemented by means of the processor means 124, as a result of which the modem banks according to the prior art and the expensive connections to said modem connections are rendered superfluous. The modem functions can be embodied both for terminating analog modem connections and for terminating xDSL connections.

An inventive subscriber line circuit 102 can be regarded as an “autonomous host”. An autonomous host of this type is able to link its functionality to the network elements 112A-E, 114, 116, which can also be regarded as servers. Said linking is effected either manually, for example by setting the partner address in the subscriber line circuit 102, or automatically, for example during booting of the subscriber line circuit 102, by means of suitable procedures, for example by means of DHCP (Dynamic Host Configuration Protocol). Complex and expensive management controllers of the kind employed hitherto can be dispensed with and so will no longer have to be administered either. This results in savings potentials in terms of the operating costs of the communication system 100.

The steps required for linking to the network elements 112A-E, 114, 116 are performed, for example, under the control of the processor means 124 and/or the protocol means 122, for instance by means of a DHCP protocol stack. This means that no further configuring will be necessary for identifying the network elements 112A-E, 114, 116 or, as the case may be, servers. Said linking can herein take place statically through the linking to all or selected network elements remaining constant having first been established during booting, for instance, or dynamically for some or all network elements, matched to the operational requirements.

As already mentioned, the network-side IP-based communication protocols, for example SIP or H.323, can according to one exemplary embodiment be terminated in the subscriber line circuit 102 and converted there into the classical ISDN or analog protocol for forwarding to the subscriber terminals 110A-B. In another exemplary embodiment it is possible to forward said protocols transparently through the subscriber line circuit 102 to the subscriber terminals 110A-B. This is referred to also as “bridging”.

Inventive subscriber line circuits 102 can provision a plurality of subscribers and their respective subscriber terminals (110A-B) simultaneously using a plurality of subscriber-side communication means 120. If the number of subscribers exceeds a certain threshold, further network-side communication means 118 can be provided to make sufficient transport capacity available. The use of a plurality of network-side communication means 118 can be provided also for reasons of redundancy so that the outage of a single interface will not jeopardize the availability of the subscriber line circuit 102.

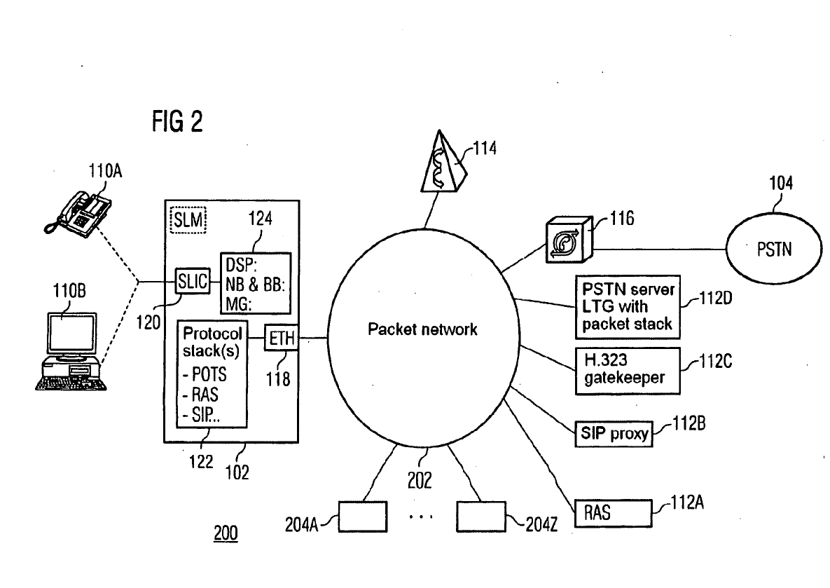

FIG. 2 shows an alternative communication system 200. In contrast to the communication system shown in FIG. 1, the subscriber line circuit 102 is connected directly to a packet-based network or packet network 202, for example the internet. A separate access network 108 is in this case not necessary.

The network elements 112A-E, 114, 116, which were already described in connection with FIG. 1 and perform the functions explained there, are again connected to the packet network 202. Attention is drawn here to the fact that not all of said network elements have to be present simultaneously in each embodiment of the invention; for example, an H.323 gatekeeper 112C is preferably to be provided if H.323 services are to be offered.

In contrast to the communication system 100 shown in FIG. 1, the arrangement selected for the exemplary communication system 200 has the advantage, inter alia, that the access network 108 is dispensed with as is hence also the administration and maintenance of an access network 108 of this type as well as the multiple interworking points between the packet network 202 and the subscriber line circuit 102. A further advantage is that the subscriber line circuit can be sited at any location permitting connection to the (global) packet network 202.

To increase the availability of the services for the subscriber it can be provided for the subscriber line circuit 102 to be connected to the packet-based network 202 with more than one connection (not shown).

All manner of network elements and terminal points, shown schematically by means of boxes 204A . . . Z, can be connected to the packet-based network 202. Said network elements can be further service severs, for example FTP servers, other data servers, web servers, video servers, time announcement services, or voice computers etc. Terminal points can be further subscriber line circuits, constructed like the subscriber line circuit 102, or terminal points such as telephony terminals and data terminals connected in any way to the internet.

The communication system according to FIG. 2 can thus support peer-to-peer operation, for example between two inventive subscriber line circuits, with a softswitch 114, for example, then no longer being needed for controlling.

1.-13. (canceled)

14. A subscriber-line circuit for a communication system, comprising:
a subscriber-side interface that connects to a subscriber terminal;
a network-side interface that connects to a communication system having a packet network;
a plurality of protocol stacks for communicating with a plurality of network elements within the communication system; and
a converter that converts information received by the network-side interface from a network-side protocol to a subscriber-side protocol and converts information received by the subscriber-side interface from the subscriber-side protocol to the network-side protocol.

15. The circuit according to claim 14, wherein the circuit is automatically linked to the network elements.

16. The circuit according to claim 15, wherein the circuit is automatically linked during a boot of the circuit.

17. The circuit according to claim 14, wherein the circuit is manually linked to the network elements.

18. The circuit according to claim 14,
wherein the subscriber terminal is a Time Division Multiplex (TDM) terminal or
wherein the subscriber terminal is a Digital Subscriber Line (DSL) terminal.

19. The circuit according to claim 18, wherein the circuit provides for terminating modem connections.

20. The circuit according to claim 18, wherein the subscriber-side communication provides a voice coding transmission of A-law or μ-law.

21. The circuit according to claim 20, wherein the subscriber-side interface transmits tones and/or announcements.

22. The circuit according to claim 21, wherein the subscriber-side interface receives tones.

23. The circuit according to claim 18, wherein the subscriber-side interface transmits tones and/or announcements.

24. The circuit according to claim 18, wherein the subscriber-side interface receives tones.

25. The circuit according to claim 18, wherein the network-side interface is an Ethernet interface.

26. A communication system having a plurality of network elements that provide services for subscriber terminals and having a subscriber-line circuit for coupling the subscriber terminal to the communication system, comprising:
a packet-based network that connects the subscriber line circuit to the network elements;
a plurality of protocol stacks within the circuit for communicating to the network elements; and
a converter that converts information received by the network-side interface from a network-side protocol to a subscriber-side protocol and converts information received by the subscriber-side interface from the subscriber-side protocol to the network-side protocol.

27. The communication system according to claim 26, wherein the packet-based network is coupled to a switching center of a circuit-switched telephone network via at least one of the network elements.

28. The communication system according to claim 27, wherein the packet based-network is an access network.

29. The communication system according to claim 26, wherein a network element is selected from the group consisting of: gatekeeper, proxy server for Voice-over-Internet Protocol (VoIP), access controllers, routers for accessing the packet-based communication network, and authentication devices.

30. The communication system according to claim 29, wherein the packet based-network is an access network.

31. The communication system according to claim 26, wherein the packet based-network is an access network.

32. The communication system according to claim 26, wherein the packet based-network is an internet.
